(19) United States
(12) Patent Application Publication
(10) Pub. No.: US 2007/0059139 A1
(43) Pub. Date: Mar. 15, 2007

(54) Rope guide for the rope of a winch of a motor vehicle or the like

(75) Inventor: Herwig Henschel, Heistenbach (DE)

Correspondence Address: GUDRUN E. HUCKETT DRAUDT, LONSSTR. 53, WUPPERTAL, 42289, DE

(73) Assignee: ROTZLER GMBH + CO. KG, Steinen (DE)

(21) Appl. No.: 10/904,009

(22) Filed: Oct. 19, 2004

(30) Foreign Application Priority Data
Oct. 20, 2003 (DE) 10349235.6

(51) Int. Cl. B60P 1/00

(52) U.S. Cl. 414/538

(57) ABSTRACT

A rope guide for a rope of a winch of a motor vehicle has a fairlead for guiding the rope and a fastening part for securing the rope guide to the motor vehicle. The fairlead and the fastening part are combined to a mountable module. The mountable module is configured to be exchangeably secured on a mount attached to the motor vehicle. The mount is a towing device having least one towing hook. The fastening part is configured to cover the mount.

### BACKGROUND OF THE INVENTION

The invention relates to a rope guide for a rope of a winch of a motor vehicle, in particular, a rescue or recovery vehicle or the like. The rope guide comprises a fairlead guiding the rope, wherein the fairlead is secured by a fastening part on a structural component of the vehicle

DE 197 13 600 A1 discloses a winch for mounting on a vehicle wherein the winch is secured on a support frame. The rope can be guided by means of a rope guide to the front or to the rear of the vehicle. On the front or rear of the vehicle, a fairlead is fixedly connected to the vehicle frame, respectively, and the rope is guided therethrough. By means of the fairlead, it is ensured that, even in the case of a slanted pulling action, a proper winding of the rope onto the drum of the winch is provided.

U.S. Pat. No. 6,471,191 discloses a fairlead that is approximately of a funnel shape wherein the funnel opens outwardly and the narrow neck of the funnel is positioned so as to face the winch. Such a guide funnel is comprised of two parts as it is subject to wear and must be exchanged after a predetermined time of operation so that even for a slanted pulling action a proper winding of the rope is ensured.

Since the rope can be guided to the front of the vehicle as well as to the rear of the vehicle in order to perform pulling actions by means of the rope, on the front side as well as on the backside of the vehicle a fairlead is provided; this is elaborate and expensive.

### SUMMARY OF THE INVENTION

It is an object of the invention to lower the technical expenditure for guiding the rope.

The invention is solved in that the fairlead is configured together with the fastening part as a detachable module wherein the fastening part is exchangeably secured on a mount provided on the motor vehicle.

Because of this configuration, it is possible to provide each vehicle with only one fairlead so that, in comparison to the prior art, a complete fairlead can be saved. When the rope is changed from the front side to the rear, the fairlead that is exchangeably secured on the front side is detached with a few manipulations and mounted on the rear of the vehicle. In this connection, it is preferably provided that the rope guide is detachably fastened on a mount that is already present on the vehicle. Such a mount is, for example, a towing device that is provided on motor vehicles, in particular, rescue vehicles or the like, on the front and rear by the manufacturer. The winch supplier must only mount the provided winch on the vehicle frame; complex work on the vehicle frame for attachment of a front fairlead and a rear fairlead is no longer necessary. The fastening part of the fairlead is configured preferably as a slip-on housing and is simply slipped onto the towing device similar to a protective housing. The housing engages thus the towing device comprising one or several towing hooks wherein for securing the slipped-on fastening housing of the fairlead fastening bolts are provided that pass through the housing and the towing hooks. It is thus necessary to provide for the towing devices or other mounts of each the vehicle, respectively, matching slip-on housings, wherein with a few manipulations by simply pulling out the fastening bolts the slip-on housing is detached from the mount secured on the vehicle in order to be reattached at the required location. When the fastening bolts are socket pins with large handles, the conversion is possible essentially without any tools.

Further features of the invention can be taken from the additional claims, the description, and the drawing, wherein in the following an embodiment of the invention will be explained in detail.

### BRIEF DESCRIPTION OF THE DRAWINGS

FIG. 1 is a perspective view onto a vehicle frame with a bumper and a towing device comprising two towing hooks attached thereto.

FIG. 2 is a view of the towing device secured on the vehicle frame with a rope guide mounted thereon.

FIG. 3 is a perspective view of the rope guide according to FIG. 2 with a fairlead and a fastening housing.

FIG. 4 is a perspective view of the rope guide with fastening housing according to FIG. 3.

FIG. 5 is a side view onto the fastening housing with a fairlead secured thereon.

FIG. 6 is a further side view onto the fastening housing.

FIG. 7 is a view onto the fastening housing with a fairlead in a view from the rear.

### DESCRIPTION OF PREFERRED EMBODIMENTS

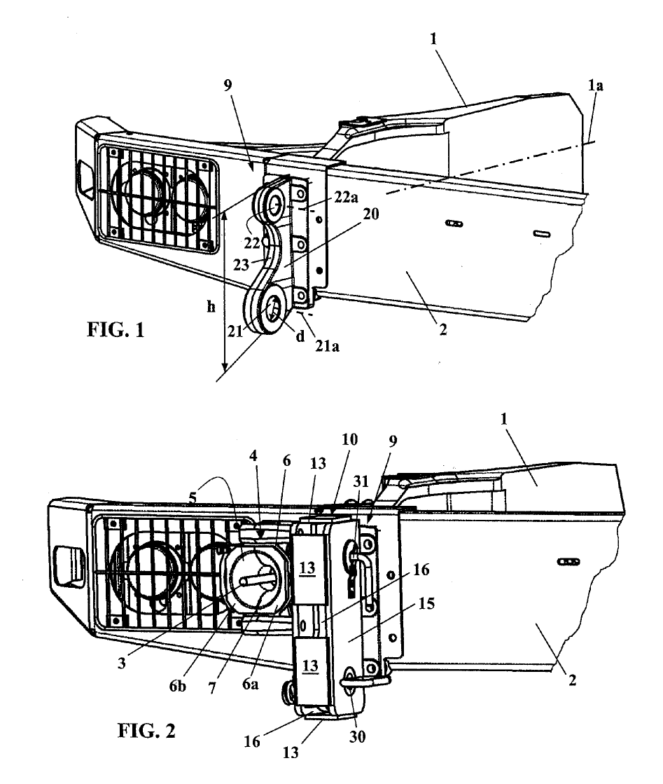

In FIGS. 1 and 2, a part of a motor vehicle frame 1 with a bumper 2 is illustrated in a perspective view. The vehicle frame can be that of a motor vehicle, in particular, a recovery vehicle, an armored recovery vehicle, or similar all-terrain vehicle. It is known to mount a rope winch, not shown in detail, on a vehicle frame wherein its rope 3 is guided in the longitudinal direction of the motor vehicle frame to the front or to the rear. Such an arrangement is disclosed in DE 197 13 600 A1, and reference is being had explicitly to the disclosure of this document.

In order to guide the rope of the winch in the correct position, a rope guide 4 for the rope 3 is provided that comprises a fairlead 5 in the illustrated embodiment and is comprised of a funnel-shaped guide 6. Such a funnel-shaped guide is described in detail in DE 199 11 073 A1, and reference is being had explicitly to the disclosure of this document.

The funnel-shaped guide 6 is comprised of two funnel halves 6a and 6b which are joined at a joining plane 7. The funnel-shaped guide 6 opens outwardly; the narrower funnel neck faces the winch. The funnel-shaped guide 6 enables a slanted pulling action of the rope 3 up to 25° without this causing any negative effects on the operation of the winch. The fairlead 5 is designed for such a so-called slanted pulling action.

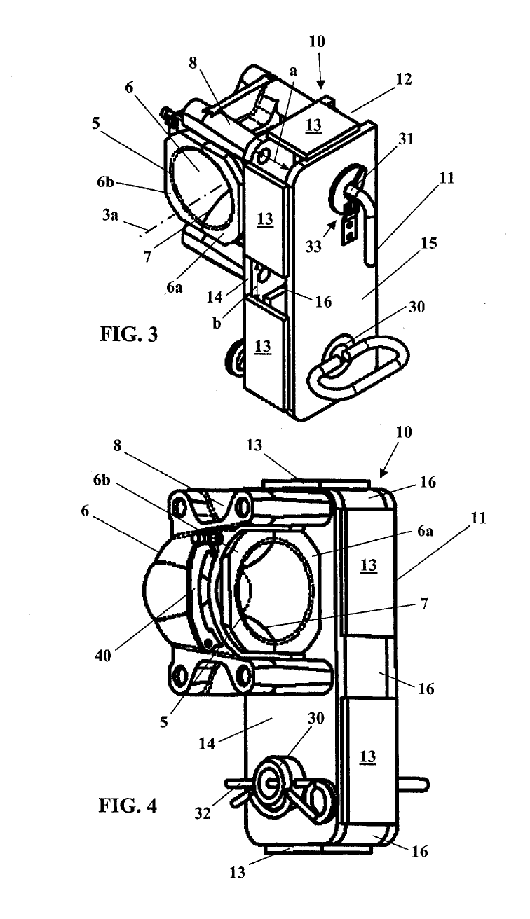

The funnel-shaped guide 6, as shown in FIGS. 3 and 4, is secured by means of a support housing 8 on a fastening part 10 that, in the illustrated embodiment, is comprised of a housing 11 that is configured in particular as a slip-on housing. This means that the housing 11 is open at a longitudinal side 12 and is configured such that the housing 11 can be slipped onto a mount 9 secured on the vehicle. This mount is configured as a towing device 20 and is secured on the vehicle to a structural component of the vehicle, for example, the vehicle frame 1 or possibly the bumper 2. The towing device 20 has at least one towing hook; in the illustrated embodiment two such towing hooks 21, 22 are provided that, relative to the plane of the vehicle frame, are positioned approximately vertically above one another. An arrangement that differs therefrom can be expedient. The towing device 20 is comprised of a flange 23 that extends in the longitudinal direction 1a of the frame forwardly away from the bumper 2 like a hump, wherein a lower projection is provided with the towing hook 21 and an upper smaller projection is provided with the towing hook 22. The axis 21a of the lower towing hook 21 and the axis 22a of the upper towing hook 22 can be positioned outside of the frame approximately parallel in front of the bumper 2.

The fastening housing 11 is comprised substantially of lateral plates 14 and 15 that are rigidly connected to one another at a spacing a by transverse plates 13. The transverse plates 13 are provided on the narrow side as well as the longitudinal side of the housing 11; however, they are spaced from one another at a spacing b. In this way, the housing 11 has a substantially open structure so that dirt and the like can fall through the windows 16 provided between the transverse plates 13.

The support housing 8 is rigidly connected to a side plate 14 of the housing 11 wherein the longitudinal center axis 3a of the fairlead 5 extends approximately parallel to the lateral plates 14 and 15.

The spacing a of the lateral plates 14 and 15 is dimensioned such that the hump-shaped flat flange 23 is secured without any great play between the lateral plates 14 and 15. The height H of the slip-on housing 11 (FIG. 7) corresponds approximately to the height h of the hump-shaped flat flange 23 of the towing device 20. The slip-on housing 11 engages thus also in the direction of height the hump-shaped flat flange 23 without great play so that the fairlead 5 with the trumpet-shaped guide funnel 6 is secured on the vehicle when slipping the slip-on housing 11 onto the flat flange 23 of the towing device 20.

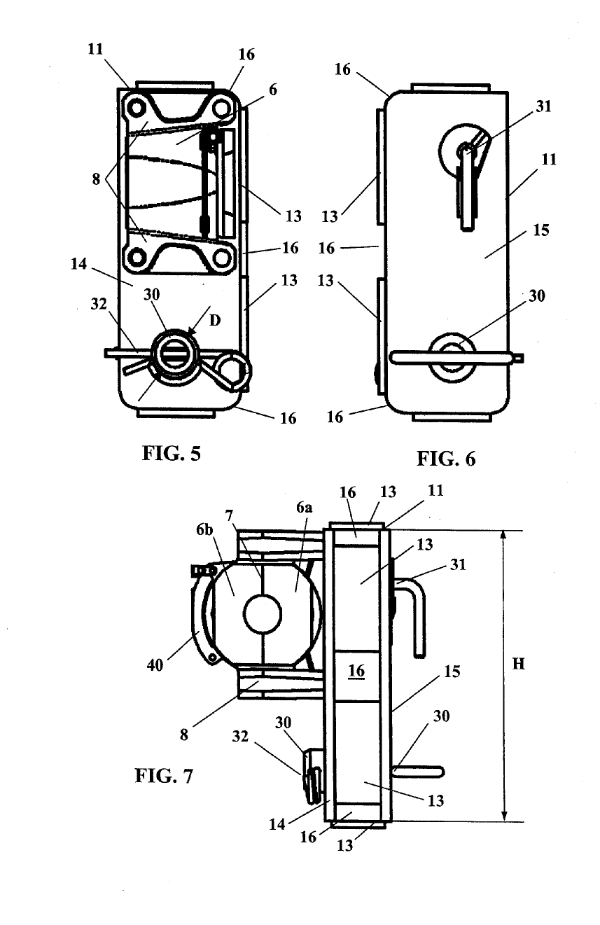

Since the slip-on housing 11 thus covers the flat flange 23 and thus also the towing hooks 21 and 22, for securing the slip-on housing 11 on the mount 9 that is embodied as a towing device 20, it is possible to provide fastening bolts 30, 31 that penetrate the lateral plates 14 and the towing hooks 21 and 22. The interior of the housing 11 is thus completely penetrated by the bolts 30 and 31, wherein the fastening bolt 30 projects with its free end past the lateral plate 14. Into its projecting free end, a securing pin 32 can be inserted in order to captively secure the fastening bolt 30. In this connection, the fastening bolt 30 has an outer diameter D (FIG. 5) that matches approximately the inner diameter d (FIG. 1) of the towing hook 21. In this way, a secure attachment of the slip-on housing 11 on the mount 9 is ensured; the housing 11 is mounted without significant play securely on the towing device 20.

In the same way, a fastening bolt 31 engages the second towing hook 22. Because the funnel-shaped guide 6 is mounted at the level of the second towing hook 22 and, therefore, no free access is provided to the free end of the fastening bolt 31 that ends in the lateral plate 14, the bolt is secured by means of a spring safety 33 on the free opposed side plate 15.

Because the fairlead 5 of the rope guide does not introduce any tensile load into the vehicle frame, but instead essentially only supports and guides the rope 3, the loads that occur can be supported without problems by means of the slip-on housing 11 mounted on the towing device 20.

When the rope 3 is not guided to the front end of the vehicle, but to the rear of the vehicle, first the funnel-shaped guide is removed from the holder by detaching an outer securing device 40 and the funnel-shaped guide is disassembled (FIG. 7). The rope 3 (FIG. 2) can then be guided through the fairlead. After releasing the securing devices, the bolts 30 and 31 are pulled so that the slip-on housing 11 together with the support housing 8 for the funnel-shaped guide 6 can be removed from the towing device 20. The user redirects the rope to the rear and slips the slip-on housing 11 that has been removed from the front side onto the rearward towing device of the vehicle, secures the slip-on housing 11 by means of the fastening bolts 30 and 31 on the towing device, and places the rope 3 into the still open fairlead 5. Now the two halves 6a and 6b of the funnel-shaped guide 6 are combined, inserted into the holder 8, and again closed by means of the securing device 40. The rope guide with its fairlead 5 is now mounted to the rear of the vehicle in accordance with the redirected rope orientation. The exchange from front to rear and vice versa can be carried out quickly and simply.

While specific embodiments of the invention have been shown and described in detail to illustrate the inventive principles, it will be understood that the invention may be embodied otherwise without departing from such principles.

What is claimed is:

1. A rope guide for a rope of a winch of a motor vehicle, the rope guide comprising:
a fairlead configured to guide the rope;
a fastening part configured to secure the rope guide to the motor vehicle;
wherein the fairlead and the fastening part are combined to a mountable module;
wherein the mountable module is configured to be exchangeably secured on a mount attached to the motor vehicle.

2. The rope guide according to claim 1, wherein the mount is a towing device comprising at least one towing hook.

3. The rope guide according to claim 2, wherein the towing device has two of the at least one towing hook.

4. The rope guide according to claim 1, wherein the fastening part is configured to cover the mount.

5. The rope guide according to claim 1, wherein the fastening part comprises a housing.

6. The rope guide according to claim 5, wherein the housing is a slip-on housing.

7. The rope guide according to claim 1, wherein the fastening part comprises at least one detachable fastening bolt for securing the fastening part on the mount.

8. The rope guide according to claim 7, wherein the at least one fastening bolt is a socket pin.

9. The rope guide according to claim 7, wherein the at least one fastening bolt is configured to penetrate a towing hook of the mount.

10. The rope guide according to claim 7, wherein the fastening part comprises a housing and wherein the housing is completely penetrated by the at least one fastening bolt.

11. The rope guide according to claim 7, further comprising a securing pin that captively secures the at least one fasting bolt.

12. The rope guide according to claim 11, wherein the securing pin is mounted outside the housing.
